(19) United States
(12) Patent Application Publication
(10) Pub. No.: US 2022/0197349 A1
(43) Pub. Date: Jun. 23, 2022

(54) PORTABLE ELECTRONIC DEVICE ENCLOSURES WITH RESILIENT MEMBERS

(71) Applicant: Hewlett-Packard Development Company, L.P., Spring, TX (US)

(72) Inventors: Wen-Chih Chen, Taipei City (TW); Kun-Hung Lin, Taipei City (TW); Jian Ming Chen, Taipei City (TW)

(73) Assignee: Hewlett-Packard Development Company, L.P., Spring, TX (US)

(21) Appl. No.: 17/606,073

(22) PCT Filed: Jul. 31, 2019
(86) PCT No.: PCT/US2019/044269

§ 371 Date: Oct. 25, 2021

(51) Int. Cl. G06F 1/16

(52) U.S. Cl. CPC G06F 1/1681; G06F 1/1616

(57) ABSTRACT

An enclosure for a portable electronic device may include a base portion with a curved wall that extends from the base portion to form an inner concavity. An engagement feature on the base portion may retain a resilient member that extends along an inner contour of the inner concavity of the wall.

### BACKGROUND

Portable electronic devices, such as notebook and laptop computers, may include an enclosure that houses internal electronic components. The upper surface of the enclosure may include, for example, a keyboard, a trackpad, various buttons, and the like. The enclosure may also include various ports, such as power adapter and/or communication ports. Many such portable electronic devices are configured with an integrated electronic display that pivots relative to the enclosure. For example, an electronic display of a laptop computer may be connected to the enclosure via a hinge assembly. The hinge assembly may include multiple discrete hinges or a single elongated hinge.

### BRIEF DESCRIPTION OF THE DRAWINGS

Non-limiting and non-exhaustive examples of the disclosure are described below, including various examples relating to the figures described below.

FIG. 1A illustrates an example of a portable electronic device with an enclosure and a pivotable electronic display.

FIG. 1B illustrates a close-up view of an example of an internal wall extending from a base portion of the enclosure for the portable electronic device.

FIG. 2A illustrates a rear view of an example portable electronic device with an electronic display connected to an enclosure via hinges.

FIG. 2B illustrates a rear close-up view of an example of an internal wall extending from a base portion of the enclosure.

FIG. 3A illustrates an example of a resilient member for insertion along an inner contour of a curved wall extending from a base portion of the enclosure.

FIG. 3B illustrates an example engagement feature comprising a groove and an end stop to retain the resilient member along an inner contour of a concavity formed by the wall.

FIG. 3C illustrates the example resilient member inserted within the groove along the inner contour of the concavity formed by the wall.

FIG. 3D illustrates a straight-on view of the example resilient member within the groove portion of the engagement feature along the inner contour of the concavity formed by the wall.

FIG. 4A illustrates a curved portion of the wall that is reinforced by the resilient member retained by the engagement feature formed along the inner contour of the concavity formed by the wall proximate a hinge.

FIG. 4B illustrates an example of a force applied to an outer surface of the wall extending from the base portion of the enclosure.

FIG. 5A illustrates an example of an internal rear wall extending from a base portion of an enclosure with reinforcing resilient members proximate the outer edges of each hinge cutout.

FIG. 5B illustrates an example of an internal rear wall extending from a base portion of an enclosure with reinforcing resilient members proximate each edge of each of the hinge cutouts.

### DETAILED DESCRIPTION

According to many of the examples described herein, a portable electronic device, such as a laptop computer, notebook computer, folding tablet device, or other hinged electronic device may include an electronic display pivotally connected to a base enclosure. For example, a laptop computer may include an electronic display connected to an enclosure via multiple hinges or a single elongated hinge. The enclosure, in some examples, may house electronic components of the portable electronic device and include a base portion and walls that extend therefrom. In some examples, the top surface of the enclosure may include interface components, such as a keyboard, a trackpad, and/or various buttons.

The walls extending from the base portion may be curved and form an inner concavity relative to the base portion. In some examples, a rear wall of the enclosure may include multiple cutouts to accommodate the hinges that connect the electronic display to the enclosure. Portions of the rear wall between the corners of the enclosure and the hinge cutouts may be susceptible to damage if the portable electronic device is dropped and/or another force is applied to the rear wall. As described herein, an engagement feature may be formed in the rear wall proximate the hinge cutouts to retain a resilient member. The resilient member may be retained along an inner contour of part of the base portion and part of the inner concavity of the wall. The resilient member reinforces the curved portions of the rear wall proximate each of the hinge cutouts.

In some examples, the wall with the hinge cutouts may extend from the base portion with a curvature to form a D-shape. That is, the wall may curve upward and back in on itself. The engagement feature to retain the resilient member may comprise, for example, a groove and an end stop. The groove may be formed along an inner contour of part of the base portion and continue along the curved wall forming the inner concavity. In some examples, the engagement feature may further include an end stop to retain an end of the resilient member in place. The resilient member may comprise, for example, a resilient metal wire or curved rod. In other examples, the resilient member may be manufactured from any combination of materials, such as metals, plastics, epoxies, carbon fibers, and other resilient materials.

In some examples, the resilient member may be referred to as a resilient spring. For instance, the resilient member may comprise an elongated, resilient metal rod formed in a shape to match a contour of an inner surface of an enclosure formed by a base portion and curved wall portion extending therefrom. Thus, the resilient member may comprise a resilient spring with an unloaded shape corresponding to a part of the base portion and a part of the wall. As an external force is applied to an outer surface of the wall, the resilient spring is loaded and exerts a counterforce to maintain the wall in its natural shape. The counterforce applied by the resilient spring helps prevent the wall from being compressed to the point of cracking or otherwise breaking.

The enclosure, including the base portion and wall extending therefrom, may be manufactured using a plastic or glass fiber resin. While such materials offer many manufacturing advantages, they can be susceptible to damage (e.g., cracking) when dropped or subjected to another damaging force. As described herein, the resilient member reinforces weak portions of the walls to prevent damage thereto.

In some examples, an enclosure for a portable electronic device can be described as having a bottom surface and a top surface that is substantially parallel to the bottom surface. In such examples, a curved wall may connect the bottom surface to the top surface. A rear portion of the curved wall may include multiple hinge cutouts or a single elongated hinge cutout to accommodate hinges that pivotally attach an electronic display to the enclosure of the portable electronic device.

The examples of the disclosure may be further understood by reference to the drawings, wherein like parts are designated by like numerals throughout. It is readily understood that the components of the disclosed examples, as generally described and illustrated in the figures herein, could be arranged and designed in a wide variety of different configurations. Thus, the following detailed description of the examples of the systems and methods of the disclosure is not intended to limit the scope of the disclosure, as claimed, but is merely representative of possible examples of the disclosure.

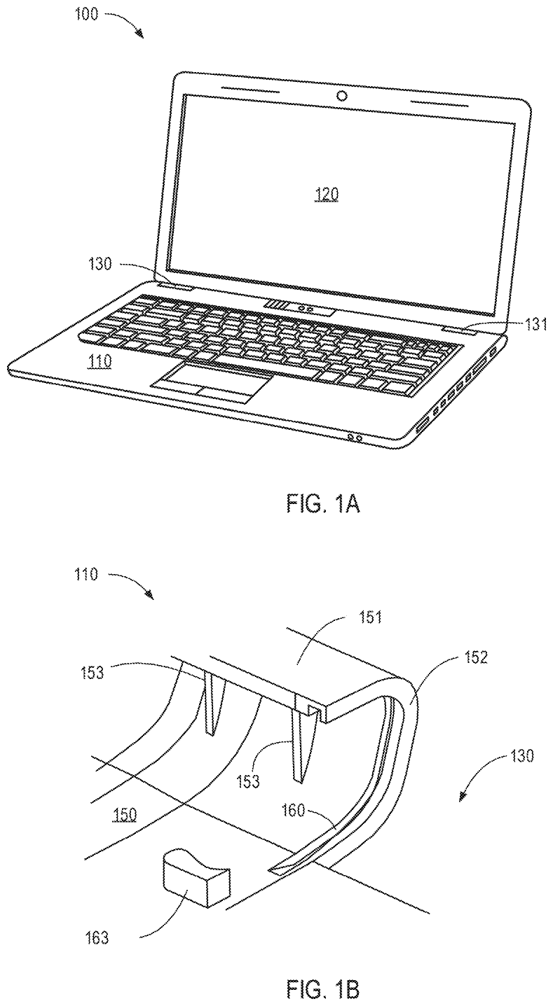

FIG. 1A illustrates an example of a portable electronic device 100 with an enclosure 110 and a pivotable electronic display 120. As illustrated, the electronic display 120 is attached to the enclosure 110 via a first hinge and a second hinge. The hinges may be accommodated by hinge cutouts 130 and 131 in portions of the rear wall of the enclosure 110 and/or the bezel of the electronic display 120. As described herein, the hinge cutouts 130 and 131 of the illustrated portable electronic device 100 are reinforced with resilient members that extend along an inner contour of concavities formed by a curved rear wall and a base portion of the enclosure 110.

FIG. 1B illustrates a close-up view of an example of a curved rear wall 152 extending from a base portion 150 of the enclosure 110 of FIG. 1A for the portable electronic device 100 of FIG. 1A. As illustrated, the base portion 150 may be substantially parallel to an upper surface 151. The curved rear wall 152 may connect the base portion 150 to the upper surface 151 of the enclosure 110. Vertical reinforcements 153 may strengthen the enclosure 110. The portion of the curved rear wall 152 proximate the hinge cutout 130 may be particularly susceptible to damage due to a lack of reinforcement.

As described below, a resilient member may be used to strengthen this portion of the curved rear wall 152. The curved rear wall 152 may include an engagement feature to retain the resilient member along an inner contour of a concavity formed by the base portion 150 and/or curved rear wall 152. In the illustrated example, the engagement feature comprises a channel 160 formed proximate the hinge cutout 130 and an end stop 163.

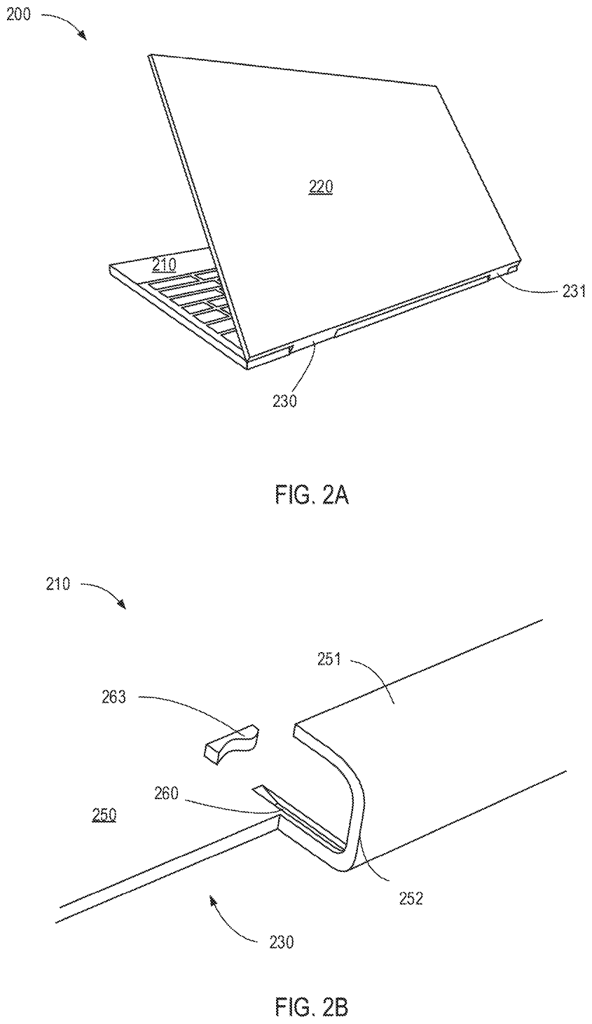

FIG. 2A illustrates a rear view of an example portable electronic device 200 with an electronic display 220 connected to an enclosure 210 via hinges within hinge cutouts 230 and 231. The hinge cutouts 230 and 231 of the illustrated portable electronic device 200 are reinforced with resilient members that extend along an inner contour of concavities formed by a curved rear wall and a base portion of the enclosure 110.

FIG. 2B illustrates a rear close-up internal view of an example of a curved wall 252 extending from a base portion 250 of the enclosure 210 of FIG. 2A. In the illustrated example, the end stop 263 can be seen through the hinge cutout 230 along with the groove 260 in the upper surface 251 of the curved wall 252.

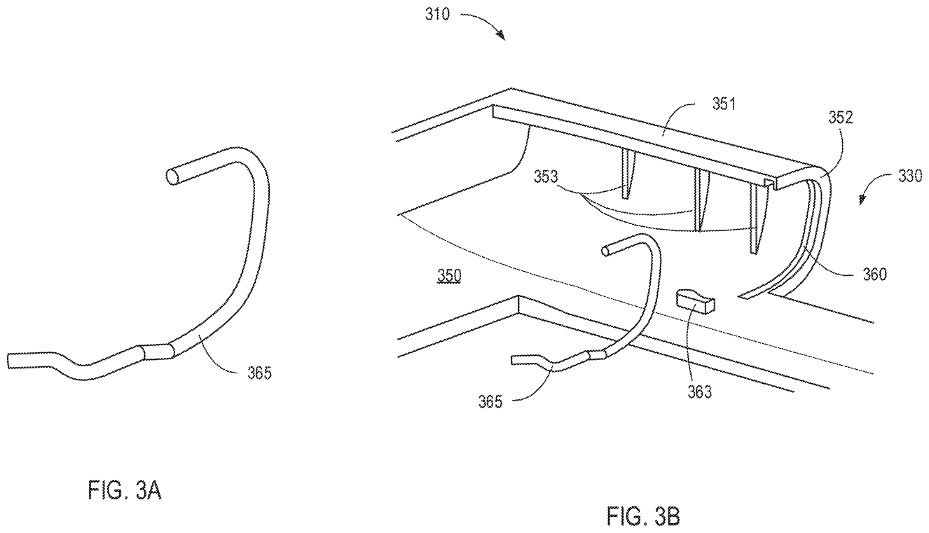

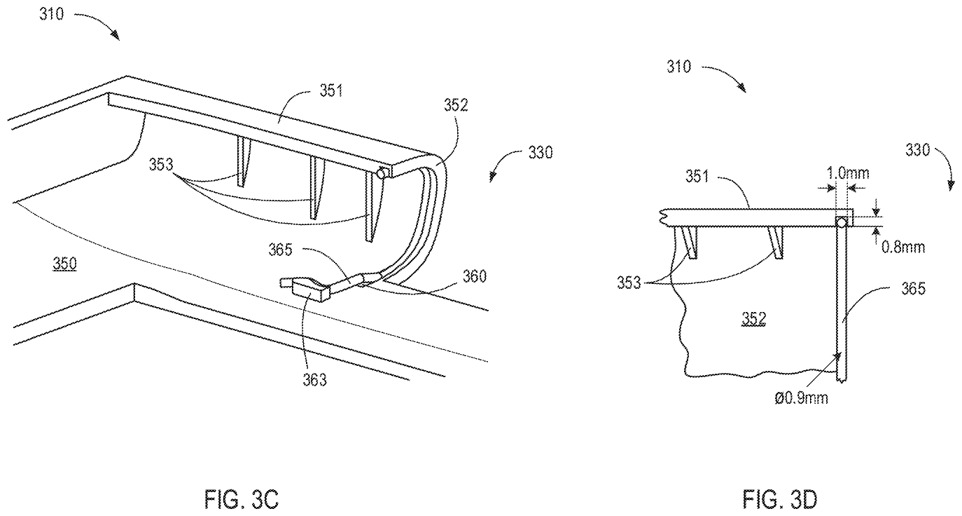

FIG. 3A illustrates an example of a resilient member 365 for insertion within a groove formed along an inner contour of a curved wall proximate a hinge cutout. In various examples, the resilient member 365 may be shaped to conform to an inner contour of a base portion, an upper portion, and/or a wall connecting the base portion to the upper surface. As referred to herein, the wall connecting a base portion to an upper surface may be described as including both the portion of the enclosure 310 extending from the base portion as well as a portion of the upper surface. The resilient member 365 may be a resilient spring, such as a resilient metal spring.

FIG. 3B illustrates an example of a resilient member 365 for insertion within a groove 360 formed along an inner contour of a curved wall 352 extending from a base portion 350 of the enclosure 310. In the illustrated example, an upper surface 351 of the enclosure 310 is substantially parallel to the base portion 350 of the enclosure 310. As previously described, the enclosure 310 may house electronic components of a portable electronic device. Vertical reinforcements 353 may strengthen the curved wall 352 joining the base portion 350 to the upper surface 351. As previously described, the curved wall 352 may be relatively weak proximate the hinge cutout 330. Accordingly, the groove 360 and an end stop 363 may form an engagement feature to retain the resilient member 365 along an inner contour of the concavity formed by the base portion 350 and the curved wall 352, where the curved wall 352 includes the upper surface 351 curving back on itself relative to the base portion 350.

FIG. 3C illustrates the example resilient member 365 inserted within the groove 360 along the inner contour of the concavity formed by the curved wall 352 joining the base portion 350 to the upper surface 351. As illustrated, the groove 360 operates in conjunction with the end stop 363 to retain the resilient member 365 proximate the hinge cutout 330. Vertical reinforcements 353 support a portion of the curved wall 352 while resilient member 365 within the groove 360 provides reinforcement to the portion of the curved wall 352 proximate the hinge cutout 330.

FIG. 3D illustrates a straight-on view of the example resilient member 365 within the groove portion (360, FIG. 3C) of the engagement feature along the inner contour of the concavity formed by the curved wall 352. Vertical reinforcements 353 reinforce a portion of the curved wall 352 connecting the base portion to the upper surface 351. The specific dimensions and shape of the resilient member 365 may be adapted and modified to conform to an inner contour of any of a wide variety of enclosure shapes and sizes. The specific illustrated example shows a groove (360, FIG. 3C) with a width up 1.0 mm formed in the curved wall 352 proximate the hinge cutout 330. The groove (360, FIG. 3C) may have a depth of 0.8 mm, such that the resilient member 365 having a diameter of 0.9 mm extends out of the groove (360, FIG. 3C) slightly. Again, alternative diameters of the resilient member 365 may be utilized in conjunction with larger or smaller grooves. For example, a thicker resilient member 365 may be utilized when additional strength is needed.

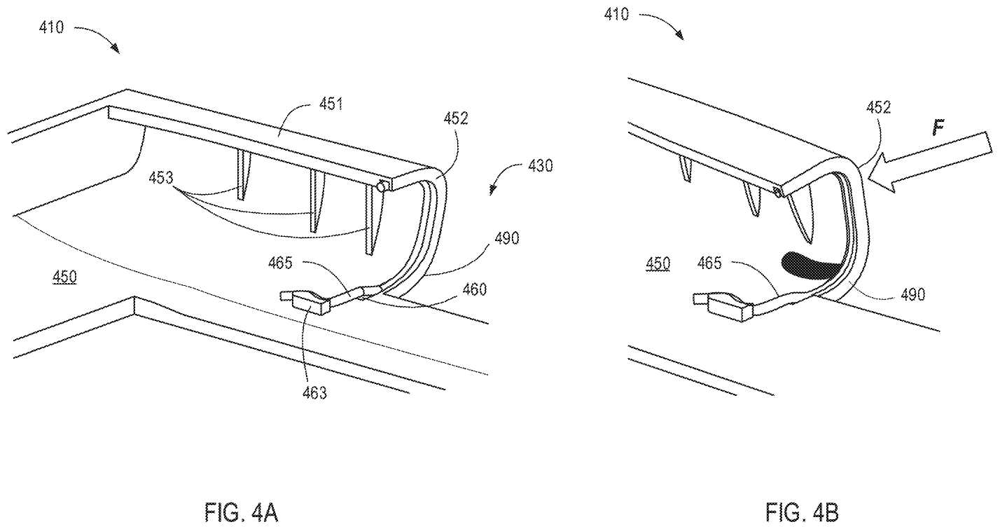

FIG. 4A illustrates a curved portion of the wall 452 extending from the base portion 450 of the enclosure 410 that is reinforced with vertical reinforcements 453 between the curved wall 452 and the upper surface 451. As illustrated, a resilient member 465 is retained by the engagement feature (e.g., groove 460 and end stop 463) proximate the hinge cutout 430. Specifically, the resilient member 465 is retained along the inner contour of the concavity formed by the curved wall 452 proximate the hinge cutout 430. In various examples, the retained resilient number 465 reinforces or strengthens the vent 490 of the curved wall 452.

FIG. 4B illustrates an example of a force F applied to an outer surface of the curved wall extending from the base portion 450 of the enclosure 410. As illustrated by the shaded region, a corner 490 of the curved wall 452 is deformed by the force F. Without the resilient member 465, the force F may break or permanently deform the curved wall 452 at the corner 490. However, as provided in the illustrated example, the resilient member 465 resists deformation and resiliently returns to its original shape. That is, the resilient member 465 exerts a counterforce to the force F and prevents the corner 490 of the curved wall 452 from cracking, breaking, and/or otherwise being permanently deformed.

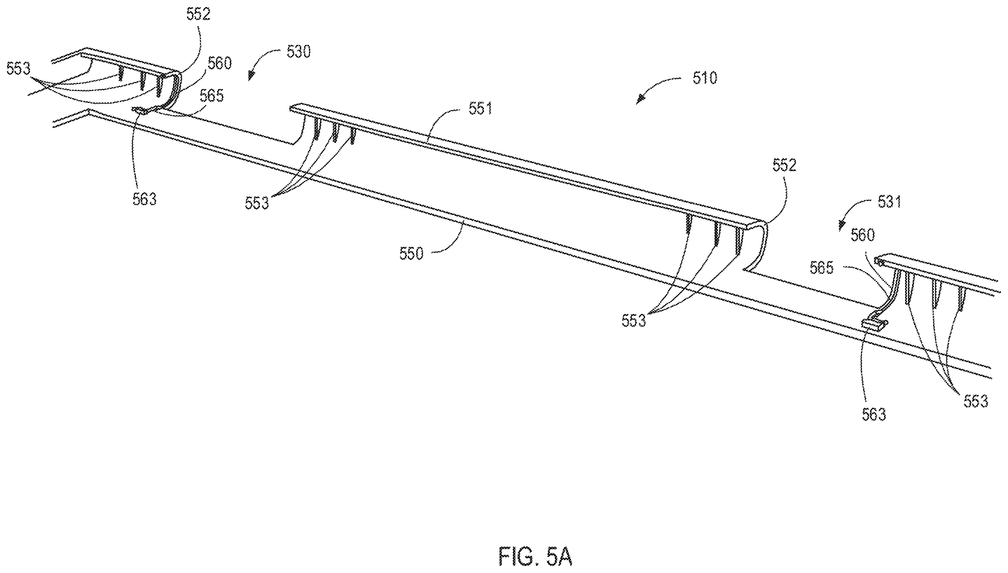

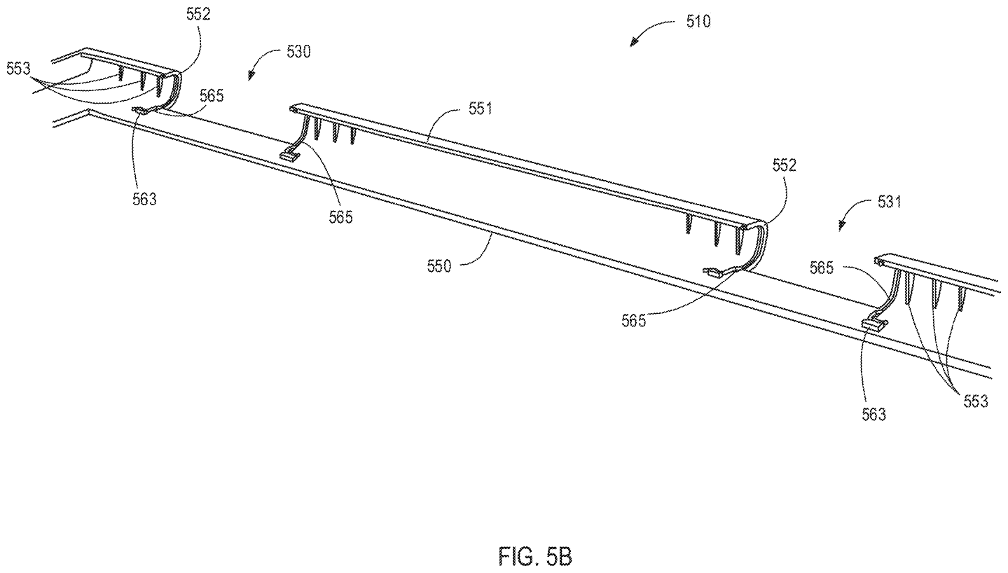

FIG. 5A illustrates an example of an internal rear curved wall 552 extending from a base portion 550 of an enclosure 510 with reinforcing resilient members 565 proximate the outer edges of each hinge cutout 530 and 531. Each resilient member 565 may be retained proximate the respective hinge cutouts 530 and 531 within grooves 560 by end stops 563. While the illustrated examples refer to an electronic display connected to the enclosure 510 via two hinges, it is appreciated that resilient members 565 may be utilized proximate one or both edges of any number of hinges connecting the electronic display to the enclosure 510.

FIG. 5B illustrates an example of an internal rear curved wall 552 extending from a base portion 550 of an enclosure 510 with reinforcing resilient members 565 proximate each edge of each of the hinge cutouts 530 and 531. As illustrated, any number of resilient members 565 may be retained within grooves by end stops 563 proximate any number of hinges and/or in other locations along the curved walls 552 connecting the base portion 550 to an upper surface 551.

While specific examples and applications of the disclosure have been illustrated and described, it is to be understood that the disclosure is not limited to the precise configurations and components disclosed herein. Accordingly, many changes may be made to the details of the above-described examples without departing from the underlying principles of this disclosure.

What is claimed is:

1. An enclosure for a portable electronic device, comprising:
a base portion;
a wall extending from the base portion with a curvature to form an inner concavity relative to the base portion;
a resilient member; and
an engagement feature to retain the resilient member extending along an inner contour of part of the base portion and part of the inner concavity of the wall.

2. The enclosure of claim 1, wherein the wall extends from the base portion with a curvature to form a D-shape, where the base portion forms the bottom of the D-shape and the wall forms the curved portion of the D-shape and the top portion of the D-shape.

3. The enclosure of claim 1, wherein the engagement feature comprises a groove formed along an inner contour of the part of the base portion and the part of the inner concavity, and wherein the resilient member is housed within the groove.

4. The enclosure of claim 1, wherein the base portion and the wall comprise one of a plastic and a glass fiber resin.

5. The enclosure of claim 1, wherein the resilient member has an unloaded shape corresponding to the inner contour of the part of the base portion and the part of the inner concavity in the wall.

6. The enclosure of claim 1, wherein the resilient member comprises one of a resilient metal and a resilient plastic.

7. The enclosure of claim 1, wherein the engagement feature comprises an end stop on the base portion and a groove to retain the resilient member extending along an inner contour of the inner cavity.

8. The enclosure of claim 1, wherein the wall comprises a cutout to accommodate a hinge for an upper portion of the enclosure, and wherein the engagement feature retains the resilient member proximate the hinge cutout.

9. A laptop computing device, comprising:
a base portion of an enclosure to house a processor and memory of the laptop;
an upper portion of an enclosure to house an electronic display pivotally attached to the base portion via a hinge;
a wall curving upward from the base portion of the enclosure that includes a hinge cutout to receive the hinge;
a resilient spring; and
a spring retainer to retain the resilient spring proximate the hinge cutout to strengthen the portion of the wall proximate the hinge cutout.

10. The enclosure of claim 9, wherein the wall extends from the base portion with a curvature to form a D-shape, where the base portion forms the bottom of the D-shape and the wall forms the curved portion of the D-shape and the top portion of the D-shape.

11. The enclosure of claim 9, wherein the spring retainer comprises a groove formed along an inner contour of a part of the base portion and a part of the inner concavity, and wherein the resilient spring is housed within the groove.

12. The enclosure of claim 9 wherein the base portion and the wall comprise plastic.

13. The enclosure of claim 9 wherein the resilient spring comprises a metal spring with an unloaded shape corresponding to a part of the base portion and a part of the wall.

14. An enclosure for a portable electronic device, comprising:
a bottom surface;
a top surface substantially parallel to the bottom surface;
a curved wall connecting the bottom surface to the top surface, wherein the curved wall includes a hinge cutout to accommodate a hinge that pivotally connects the base enclosure to an electronic display;
a groove formed in an interior surface of the curved wall proximate the hinge cutout; and
a resilient metal spring inserted within the groove to strengthen the curved wall proximate the hinge cutout.

15. The base enclosure of claim 14, wherein the resilient metal spring has a shape corresponding to the groove formed in the interior surface of the curved wall when loaded to an amount less than the modulus of resilience.
